(19) United States
(12) Patent Application Publication
(10) Pub. No.: US 2014/0265781 A1
(43) Pub. Date: Sep. 18, 2014

(54) PANEL WITH MAGNETIC HINGE

(71) Applicant: ADT US HOLDINGS, INC., Boca Raton, FL (US)

(72) Inventors: Timothy Albert RADER, Lake Worth, FL (US); Anne-Marie ROUSE, Wellington, FL (US); Diarmuid MacMAHON, Dublin (IE); Mel REYNOLDS, Wicklow (IE); Jerome TOBIN, Wicklow (IE)

(73) Assignee: ADT US HOLDINGS, INC., Boca Raton, FL (US)

(21) Appl. No.: 14/198,094

(22) Filed: Mar. 5, 2014

Related U.S. Application Data
(60) Provisional application No. 61/787,899, filed on Mar. 15, 2013.

(51) Int. Cl. E05C 17/56

(52) U.S. Cl. CPC E05C 17/56
USPC 312/319.2

(57) ABSTRACT

A panel includes a housing. The housing may have a hinge closed magnet and a hinge opened magnet. The panel may include a door magnetically hinged to the housing for positioning the door between a closed position and an open position. The door may have a door hinge magnet. The door hinge magnet is magnetically attracted to the hinge closed magnet to retain the door in the closed position. The door hinge magnet is magnetically attracted to the hinge opened magnet to retain the door in the open position.

### CROSS-REFERENCE TO RELATED APPLICATION

This application is related to and claims priority to U.S. Provisional Patent Application Ser. No. 61/787,899 filed Mar. 15, 2013, entitled MAGNETIC HINGE, the entirety of which is incorporated herein by reference.

### FIELD OF THE INVENTION

The present invention relates to a method and system for a magnetic hinge, and in particular to a magnetic hinge for use with a cover of a user interface panel.

### BACKGROUND OF THE INVENTION

User interface panels are prevalent in today's electronic world. For example, user interface panels, such as displays, keypads, and the like are part of typical security systems and are also found on many appliances in homes and businesses. Some existing panels including keypads that remain exposed to the environment being monitored, i.e., coverless keypads. While coverless keypad panels provide easy access to the interface panel, the exposed keypad invites accidental button presses by a passerby, which may inadvertently trigger an alarm system or some unintended operation.

Other existing interface panels include a cover that can be rotated or moved to expose the actual interface, e.g., touch display, buttons, keys pads, etc., thereby providing protection from accidental button presses. The covers are routinely made from inexpensive plastic that are rotatably coupled to the panel housing via small mechanical hinges. The hinges include small tabs or openings that mate with corresponding tabs or openings on the housing itself, among other mechanically connected hinges known in the art. These tabs are prone to breakage through inadvertent over-rotation of the cover, or by being knocked into when the cover is in an open position. As a result of breakage, panel owners must contact the panel provider to obtain a new cover (or an entirely new unit if the cover cannot be replaced), during which time the actual interface will be exposed to accidental button presses until the new cover is received. Receiving a new cover or unit adds expense to either the owner, who must pay for the replacement cover, or the panel provider if the provider does not charge for the replacement. Further, panel providers must obtain and stock replacement covers so that they are available for panel owners. Should panel models change over time, the panel providers may be left with unwanted and unusable stock of panel covers.

### SUMMARY OF THE INVENTION

The invention advantageously provides a method and system for an interface panel having a magnetically hinged panel door.

According to one embodiment, a panel is provided. The panel includes a housing. The housing may have a hinge closed magnet and a hinge opened magnet. The panel may include a door magnetically hinged to the housing for positioning the door between a closed position and an open position. The door may have a door hinge magnet. The door hinge magnet is magnetically attracted to the hinge closed magnet to retain the door in the closed position. The door hinge magnet is magnetically attracted to the hinge opened magnet to retain the door in the open position.

According to another embodiment, a panel is provided. The panel includes a housing that defines a faceplate having front portion and a back portion opposite the front portion. The back portion of the faceplate defines a plateau and an outer periphery. The plateau may be inwardly recessed from the front surface of housing. The outer periphery may be substantially parallel with the plateau and non-coplanar. The housing may include a hinge opened magnet in which the hinge opened magnet is affixed to the outer periphery. The housing may include a hinge closed magnet that is affixed to the plateau and in a parallel relationship and non-coplanar with the hinge opened magnet.

According to another embodiment, a panel is provided. The panel includes a housing. The housing may have a hinge closed magnet and a hinge opened magnet. The housing may have an indentation forming a pivot point located in between the hinge closed magnet and hinge opened magnet. The panel may include a door removably attached to the housing. The door has a door hinge magnet. The interaction of the hinge closed magnet, hinge open magnet and door hinge magnet forms a magnetic hinge for allowing the door to be magnetically pivotable about the pivot point.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an upper perspective view of an exemplary interface panel with the magnetically hinged door closed constructed in accordance with the principles of the invention;

FIG. 2 is an upper perspective view of an exemplary interface panel with the magnetically hinged door open constructed in accordance with the principles of the invention;

FIG. 3 is a rear assembly view of an exemplary magnetically hinged door constructed in accordance with the principles of the invention;

FIG. 4 is a rear view of an exemplary magnetically hinged door constructed in accordance with the principles of the invention;

FIG. 5 is a rear perspective view of an exemplary magnetically hinged door constructed in accordance with the principles of the invention;

FIG. 6 is a rear perspective view of another embodiment of an exemplary magnetically hinged door constructed in accordance with the principles of the invention;

FIG. 7 is a rear perspective view of an exemplary magnetically hinged housing constructed in accordance with the principles of the invention;

FIG. 8 is a front perspective view of an exemplary magnetically hinged housing constructed in accordance with the principles of the invention;

FIG. 9 is a front view of an exemplary magnetically hinged housing constructed in accordance with the principles of the invention; and

FIG. 10 is a virtual cross section view taken through an assembled interface panel constructed in accordance with the principles of the invention.

### DETAILED DESCRIPTION OF THE INVENTION

The invention relates to an interface panel having a magnetically hinged panel door. Accordingly, the system, device and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Referring now to the drawing figures in which like reference designators refer to like elements, there is shown in FIG. 1 an upper perspective view of one embodiment of the interface panel with the magnetically hinged door closed constructed in accordance with the principles of the invention and designated generally as “10”. Interface panel 10 includes a panel door 12 that is magnetically hinged to panel housing 14. For ease of explanation, the actual interface components such as electronics, displays, buttons, keys, and the like are not shown, it being understood that such elements may be part of an operating interface. As such, only the housing 14, door 12 and components of the magnetic hinge are described herein. Panel housing 14 may define inward cavity 16 in which panel door 12 may be positionable substantially within inward cavity 16 when panel door 12 is in a closed position, as shown in FIG. 1. Panel door 12 allows a user to grasp, hook or otherwise apply an outward force to exposed side 18 of the panel 12 such that panel door 12 may be opened, as shown in FIG. 2. Door 12 and panel housing 14 may be constructed of plastic or any other suitable polymer or material. Interface panel 10 may be mounted on a wall or other surface that is capable of securing panel housing 14 thereto.

FIG. 2 is an upper perspective view of interface panel 10 with the magnetically hinged panel door 12 in an open position. Panel housing 14 may include faceplate 20 having a front portion facing inward cavity 16 and a back portion opposite the front portion. A general movement for opening and closing panel door 12 is shown in FIG. 2. Further, exposed side 18 of panel door 12 may be tapered in order to allow a user to more easily apply a moving force to panel door 12 in order to move panel door 12 to an open position.

A rear assembly view of an embodiment of magnetically hinged panel door 12 constructed in accordance with the principles of the invention is described with reference to FIG. 3. Panel door 12 may include cover 22 and strip 24 affixed to cover 22. Cover 22 has a plurality of sides including exposed side 18 in which one or more of the plurality of sides may be tapered or shaped to conform to the shape of panel housing 14. Cover 22, i.e., part of panel door 12, may define one or more hinge magnet recesses 26 (collectively referred to herein as “hinge magnet recess 26”) for accepting one or more door hinge magnets 28 (collectively referred to herein as “door hinge magnet 28”). Cover 22 may further define one or more door locking recess 30 (collectively referred to herein as “door locking recess 30”) for accepting one or more door lock magnets 32 (collectively referred to herein as “door lock magnet 32”). Strip 24 may be affixed to cover 22 to protect and retain door hinge magnet 28 and door lock magnet 32. Strip 24 may be made of Mylar or other material(s) known in the art. In one embodiment, door hinge magnet 28 and/or door lock magnet 32 may be pressed into and/or bonded to cover 22.

FIG. 4 is a rear view of magnetically hinged panel door 12. FIG. 4 shows assembled panel door 12 in which strip 24 is affixed to cover 22. Door hinge magnets 28 are shown in dashed lines as, when panel door 12 is assembled, magnets 28 are covered by strip 24. Door lock magnet 32 is also shown in dashed lines, as when panel door 12 is assembled, door lock magnet 32 is covered by strip 24. The example dimensions shown in FIG. 4 are in millimeter units.

FIG. 5 is a rear perspective view of an exemplary magnetically hinged door 12 in which door hinge magnets 28 may form part of the panel door hinge, i.e., the interaction of door hinge magnets 28, hinge opened magnets 42 (FIG. 8) and hinge closed magnets 44 (FIG. 8) form the door hinge for positioning the door between a closed position and an open position. FIG. 6 is a rear perspective view of another embodiment of a magnetically hinged panel door 12 in which a single elongated magnet 34 forms part of the door hinge. Alternatively, one or more door hinge magnets 28 of one or more magnet sizes may be used in accordance with the teachings described herein.

An embodiment of a magnetically hinged panel housing 14 constructed in accordance with the principles of the invention is described with reference to FIG. 7. Housing 14 includes frame 36 that may be located substantially at the outer perimeter of the back portion of faceplate 20. The back portion of faceplate 20 includes outer periphery 38 and plateau 40 in which plateau 40 may be inwardly recessed from the front surface 31 of frame 36 as opposed to outer periphery 38. One or more hinge opened magnets 42 (collectively referred to herein as “hinge opened magnet 42”) may be affixed to a portion of outer periphery 38 as shown in FIG. 7. Hinge opened magnet 42 retains panel door 12 when panel door is in an open position. One or more hinge closed magnets 44 (collectively referred to herein as “hinge closed magnet 38”) may be affixed to a portion of plateau 40 in a parallel relationship and non-coplanar with hinge opened magnet 42, as shown in FIG. 7. Hinge closed magnets 44 may be positioned closer to the center of frame 36 than hinge opened magnets 42.

Further, one or more housing lock magnets 46 (hereinafter “housing lock magnet 46”) may be affixed to a portion of plateau 40. Although FIG. 7 shows a pair of hinge opened magnets 42 and a pair of hinged closed magnets 44, and panel door 12 is described as having a pair of door hinge magnets 28 or single magnet 34, the invention is not limited to such. It is contemplated that any number of magnets can be used subject to being strong enough to provide proper operation.

When panel door 12 is in the closed position, housing lock magnet 46 is attracted to door locking magnet 26, and door hinge magnets 28 (or 34) are attracted to hinge closed magnets 44 to retain panel door 12 in the closed position, as shown in FIG. 1. When door 12 is in the open position, door hinge magnets 28 (or 34) are attracted to hinge open magnets 36 to retain panel door 12 in the open position, as shown in FIG. 2. Accordingly, the positioning of the door hinge magnet 28 and hinge open/close magnets (42/44) advantageously allows panel door 12 to pivot open and close without having to be physically attached to panel housing 14 with a mechanical hinge mechanism, i.e., panel door 12 is removably attached to the housing in that panel door 12 is removable from the housing by overcoming the magnetic attraction between at least one of: the door hinge magnet 28 and the hinge opened magnet 42, the door hinge magnet 28 and the hinge closed magnet 44, and the door lock magnet 32 and the housing lock magnet 46.

FIG. 8 is a front perspective view of an exemplary magnetically hinged housing 14. Hinge opened magnets 42, hinge closed magnets 44 and door lock magnet 40 are shown in dashed lines as, when viewed from the top, magnets 42, 44 and 46 are affixed to the back portion (inside) of faceplate 20 and are not visible. Outer periphery 38 is shown in FIG. 8 as a rounded region such that plateau 40 is recessed with respect thereto.

FIG. 9 is a front view of an exemplary magnetically hinged panel housing 14. Hinge opened magnets 42, hinge closed magnets 44 and housing lock magnet 46 are shown in dashed lines as, when viewed from in front of faceplate 20, hinge opened magnets 42, hinge closed magnets 44 and housing lock magnet 46 are affixed to the back portion of faceplate 20, i.e., outer periphery 38 and plateau 40, respectively, and are not visible. Outer periphery 38 may be a rounded region. The example dimensions shown in FIG. 9 are in millimeter units. However, the invention is not limited to this dimensional arrangement.

FIG. 10 is a virtual cross section view taken through an assembled interface panel 10. The view is referred to as “virtual” because the view shows all hinge and locking magnets which a view through an actual section would show either magnets 32 and 46 or magnets 28, 42 and 44. In one embodiment, door hinge magnet 28 and hinge opened magnet 42 are substantially transversely co-planar when the door is in the closed position.

In operation, panel door 12 is rotated from a closed position (FIG. 1) to an open position (FIG. 2) or vice-versa, in which the relationship among magnets advantageously allows panel door 12 to be magnetically pivotable about a pivot point without the use of physically connected mechanical parts such as a mechanical hinge, i.e., panel door 12 is not physically connected to housing 14. When closed, door hinge magnet 28 is attracted to hinge closed magnet 44. As panel door 12 is rotated to the open position, door hinge magnet 28 loses attraction to hinge closed magnet 44, but is attracted to hinge opened magnet 42 in which cover 16 pivots about frame 36 at pivot region 48. Pivot region 48 includes an indentation forming a pivot point located in between the hinge closed magnet and hinge opened magnet. Pivot region 48 prevents door 12 from sliding along frame 36, instead facilitating the pivoting motion. Pivot region is an indentation in housing 14.

The magnets described herein can be of any suitable material subject to not impacting operation of the electronics of interface panel 10 and providing sufficient strength to ensure proper operation of the hinge. Further, although the embodiments described herein reference a user interface panel, such as a panel used in a security system, the invention is not limited to such. It is contemplated that the magnetic hinge of the invention can be used in any arrangement where a cover is used.

It will be appreciated by persons skilled in the art that the invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A panel, comprising:
a housing, the housing having:
a hinge closed magnet; and
a hinge opened magnet;
a door magnetically hinged to the housing for positioning the door between a closed position and an open position, the door having a door hinge magnet;
the door hinge magnet being magnetically attracted to the hinge closed magnet to retain the door in the closed position; and
the door hinge magnet being magnetically attracted to the hinge opened magnet to retain the door in the open position.

2. The panel of claim 1, wherein:
the door further includes a door lock magnet; and
the housing further includes a housing lock magnet, the door lock magnet being magnetically attracted to the housing lock magnet to retain the door in the closed position.

3. The panel of claim 1, further comprising a pivot point, the door being magnetically pivotable about the pivot point to position the door from the open position to the closed position and from the closed position to the open position.

4. The panel of claim 1, wherein the door and the housing form a security system panel enclosure.

5. The panel of claim 1, wherein the door hinge magnet and the hinge opened magnet are substantially transversely co-planar when the door is in the closed position.

6. The panel of claim 5, wherein the door hinge magnet and the hinge opened magnet are substantially parallel and non-coplanar when the door is in the open position.

7. The panel of claim 1, wherein the door further defines a recess, the door hinge magnet being positioned within the recess.

8. The panel of claim 1, wherein the housing further includes a frame having an outer periphery, the hinge opened magnet being affixed to the outer periphery.

9. The panel of claim 8, wherein the frame further includes a plateau, the plateau being inwardly recessed from the front surface of the frame, the hinge closed magnet being affixed to the plateau.

10. The panel of claim 1, wherein the housing defines a cavity, the door being positionable within the cavity when in the lock position.

11. A panel, comprising:
a housing, the housing defining a faceplate having front portion and a back portion opposite the front portion, the back portion of the faceplate defining a plateau and an outer periphery, the plateau being inwardly recessed from the front surface of housing, the outer periphery being substantially parallel with the plateau and non-coplanar with the plateau;
the housing including:
a hinge opened magnet, the hinge opened magnet being affixed to the outer periphery; and
a hinge closed magnet, the hinge closed magnet being:
affixed to the plateau; and
in a parallel relationship and non-coplanar with the hinge opened magnet.

12. The panel of claim 11, further comprising:
a door having a door hinge magnet, the door hinge magnet, hinge opened magnet and hinge closed magnet forming a magnetic hinge;
the door hinge magnet being magnetically attracted to the hinge closed magnet to retain the door in the closed position; and
the door hinge magnet being magnetically attracted to the hinge opened magnet to retain the door in the open position.

13. The panel of claim 12, the housing further including a housing lock magnet, the housing lock magnet being affixed to the plateau; and
the door further including a door lock magnet, the door lock magnet being magnetically attracted to the housing lock magnet to retain the door in the closed position.

14. The panel of claim 13, wherein the door is removably attached to the housing, the door being removable from the housing by overcoming the magnetic attraction between at least one of: the door hinge magnet and the hinge opened magnet, the door hinge magnet and the hinge closed magnet, and the door lock magnet and the housing lock magnet.

15. The panel of claim 12, further comprising a pivot point, the door being magnetically pivotable about the pivot point to position the door from the open position to the closed position and from the closed position to the open position.

16. The panel of claim 12, wherein the door and the housing form a security system panel enclosure.

17. The panel of claim 12, wherein the door hinge magnet and the hinge opened magnet are substantially transversely co-planar when the door is in the closed position.

18. The panel of claim 12, wherein the door hinge magnet and the hinge closed magnet are substantially parallel and non-coplanar when the door is in the open position.

19. The panel of claim 12, wherein the housing and the front portion of the faceplate define an inward cavity, the door being positionable within the inward cavity when in the lock position.

20. A panel, comprising:
a housing, the housing having:
a hinge closed magnet;
a hinge opened magnet; and
an indentation forming a pivot point located in between the hinge closed magnet and hinge opened magnet;
a door removably attached to the housing, the door having a door hinge magnet; and
the interaction of the hinge closed magnet, hinge open magnet and door hinge magnet forming a magnetic hinge for allowing the door to be magnetically pivotable about the pivot point.
